(19) United States
(12) Patent Application Publication
(10) Pub. No.: US 2024/0224029 A1
(43) Pub. Date: Jul. 4, 2024

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Jiren HAN, Shenzhen (CN); Yin GAO, Shenzhen (CN); Dapeng LI, Shenzhen (CN)

(73) Assignee: ZTE CORPORATION, Shenzhen (CN)

(21) Appl. No.: 18/411,158

(22) Filed: Jan. 12, 2024

Related U.S. Application Data
(63) Continuation of application No. PCT/CN2021/131897, filed on Nov. 19, 2021.

(51) Int. Cl. H04W 12/06; H04W 12/76; H04W 84/06

(52) U.S. Cl. CPC H04W 12/06; H04W 12/76; H04W 84/06

(57) ABSTRACT

Method, device and computer program product for wireless communication are provided. A method includes: transmitting, by a first wireless communication node to a second wireless communication node, unmanned aerial vehicle, UAV, grouping information, wherein the UAV grouping information comprises at least one of a group identifier or UAV Group Authorized Information.

### CROSS-REFERENCE TO RELATED PATENT APPLICATIONS

This application is a Continuation of PCT Application No. PCT/CN2021/131897, filed Nov. 19, 2021, incorporated herein by reference in its entirety.

### TECHNICAL FIELD

This document is directed generally to wireless communications.

### BACKGROUND

An Unmanned Aerial System (UAS) is the combination of an Unmanned Aerial Vehicle (UAV), sometimes called a drone, and a UAV controller (UAVC). A UAV is generally an aircraft without a human pilot on board (but there may still be a human pilot on board in some cases). The UAV can be controlled from an operator via a UAV controller and has a range of autonomous flight capabilities.

### SUMMARY

UAVs range in size and weight from small, light aircraft often used for recreational purposes to large, heavy aircraft which are often more suited to commercial applications. Regulatory requirements vary across this range and vary on a regional basis. In some applications, multiple UAVs may work together as a group for specific purposes, such as relaying and monitoring. However, the process and configurations for grouping UAVs are still unclear.

The present disclosure relates to methods, devices, and computer program products for wireless communication, which can allow UAV grouping information to be transmitted between wireless communication nodes.

One aspect of the present disclosure relates to a wireless communication method. In an embodiment, the wireless communication method includes: transmitting, by a first wireless communication node to a second wireless communication node, unmanned aerial vehicle, UAV, grouping information, wherein the UAV grouping information comprises at least one of a group identifier or UAV Group Authorized Information.

Another aspect of the present disclosure relates to a wireless communication method. In an embodiment, the wireless communication method includes: receiving, by a second wireless communication node from a first wireless communication node, unmanned aerial vehicle, UAV, grouping information, wherein the UAV grouping information comprises at least one of a group identifier or UAV Group Authorized Information.

Another aspect of the present disclosure relates to a wireless communication method. In an embodiment, the wireless communication method includes: receiving, by a third wireless communication node from a second wireless communication node, UAV related information to a third wireless communication node, and the UAV related information comprises at least one of: a group identifier, UAV Group Authorized Information, a UAV identifier, or UAV Differentiation Information.

Another aspect of the present disclosure relates to a wireless communication node. In an embodiment, the wireless communication node includes a communication unit and a processor. The processor is configured to transmit, to a second wireless communication node, unmanned aerial vehicle, UAV, grouping information, wherein the UAV grouping information comprises at least one of a group identifier or UAV Group Authorized Information.

Another aspect of the present disclosure relates to a wireless communication node. In an embodiment, the wireless communication node includes a communication unit and a processor. The processor is configured to: receive, from a first wireless communication node, unmanned aerial vehicle, UAV, grouping information, wherein the UAV grouping information comprises at least one of a group identifier or UAV Group Authorized Information.

Another aspect of the present disclosure relates to a wireless communication node. In an embodiment, the wireless communication node includes a communication unit and a processor. The processor is configured to: receive, from a second wireless communication node, UAV related information to a third wireless communication node, and the UAV related information comprises at least one of: a group identifier, UAV Group Authorized Information, a UAV identifier, or UAV Differentiation Information.

Various embodiments may preferably implement the following features:

Preferably or in some embodiments, the UAV Group Authorized Information indicates whether a UAV is authorized to work in a group.

Preferably or in some embodiments, the first wireless communication node is configured to receive UAV information, and transmit the UAV grouping information according to the UAV information.

Preferably or in some embodiments, the UAV information comprises at least one of a UAV identifier or UAV Differentiation Information.

Preferably or in some embodiments, the UAV Differentiation Information comprises at least one of a scheduled communication time, a stationary indication, a power consumption level, flight path information, or flight height information.

Preferably or in some embodiments, the UAV information is received from the second wireless communication node, and the UAV information is transmitted via a Radio Access Network, RAN, Configuration Update message, a Handover Required message, a Path Switch Request message, a Protocol Data Unit, PDU, Session Resource Modify Indication message, an Initial UE Message message, or an Uplink Non-access stratum, NAS, Transport message.

Preferably or in some embodiments, the UAV information is received from the second wireless communication node, and the UAV grouping information is transmitted via a RAN Configuration Update Acknowledge message, a Handover Command message, a Path Switch Request Acknowledge message, a PDU Session Resource Modify Confirm message, or a Downlink NAS Transport message.

Preferably or in some embodiments, the UAV information is received from a UAV, and the UAV grouping information is transmitted via an Initial User Equipment, UE, Context Setup Request message, a Handover Request message, a Downlink RAN Configuration Transfer message, or a Downlink NAS Transport message.

Preferably or in some embodiments, the UAV information is received from the UAV via NAS signaling.

Preferably or in some embodiments, the first wireless communication node is configured to receive a response message from the second wireless communication node, and the response message is transmitted via an Initial UE Context Setup Response message or a Handover Request Acknowledgement message.

Preferably or in some embodiments, the second wireless communication node is configured to transmit UAV information to the first wireless communication node, and receive the UAV grouping information in response to the UAV information.

Preferably or in some embodiments, the second wireless communication node is configured to transmit UAV related information to a third wireless communication node, and the UAV related information comprises at least one of: a group identifier, UAV Group Authorized Information, a UAV identifier, or UAV Differentiation Information.

Preferably or in some embodiments, the UAV related information is transmitted via a Next Generation Radio Access Network, NG-RAN, Configuration Update message, a Handover Request message, or a Retrieve UE Context Request message.

Preferably or in some embodiments, the second wireless communication node is configured to receive a response message from the third wireless communication node, and the response message is transmitted via an NG-RAN Configuration Acknowledge message, a Handover Request Acknowledge message, or a Retrieve UE Context Response message.

Preferably or in some embodiments, the third wireless communication node is configured to transmit a response message to the second wireless communication node, and the response message is transmitted via an NG-RAN Configuration Acknowledge message, a Handover Request Acknowledge message, or a Retrieve UE Context Response message.

The present disclosure relates to a computer program product including a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of transmitting UAV grouping information according to an embodiment of the present disclosure.

FIG. 2 shows a schematic diagram of transmitting UAV grouping information according to another embodiment of the present disclosure.

FIG. 3 shows a schematic diagram of transmitting UAV related information between two NG-RAN nodes according to an embodiment of the present disclosure.

FIG. 4 shows an example of a schematic diagram of a wireless communication node according to another embodiment of the present disclosure.

FIG. 5 shows a flowchart of a wireless communication method according to an embodiment of the present disclosure.

FIG. 6 shows a flowchart of another wireless communication method according to an embodiment of the present disclosure.

FIG. 7 shows a flowchart of another wireless communication method according to an embodiment of the present disclosure.

### DETAILED DESCRIPTION

In new radio (NR), new architecture and new features of the base station are introduced. The NR base station can be also called gNB. The interface different gNBs is called Xn. The gNBs can get UE (user equipment) related information from the core network via the NG interface.

In some embodiments, a gNB may transmit, receive, or exchange UAV grouping related information with the core network or another gNB.

In some embodiments, the UAV grouping related information can include at least one of: a UAV identifier (ID), UAV Differentiation Information, a Group ID, and/or UAV Group Authorized Information of one or more corresponding UAVs.

In some embodiments, the UAV Differentiation Information can comprise at least one of: a scheduled communication time, a stationary indication, a power consumption level, flight path information, and/or flight height information of one or more corresponding UAVs.

In some embodiments, the scheduled communication time indicates the scheduled working time of one or more corresponding UAVs. For example, the scheduled communication time may be all-day or a period of scheduled time.

In some embodiments, the stationary indication indicates the stationary state of one or more corresponding UAVs, such as stationary or dynamic.

In some embodiments, the flight path information can comprise at least one of the parameters: way point location and/or time stamp information. In some embodiments, the way point location is the form of the location coordinates. In some embodiments, the way point location includes location coordinates of one or more corresponding UAVs. In some embodiments, the time stamp information includes absolute time information. For example, absolute time information can be in a format YY-MM-DD HH:MM:SS, in which YY indicates year, the former MM indicates month, DD indicates date, HH indicates hour, the latter MM indicates minute, and SS indicates second.

In some embodiments, the flight height information includes information about the height of one or more corresponding UAVs above the sea level.

In some embodiments, the UAV Group Authorized Information is to indicate whether the UAV is authorized to work in a group.

In some embodiments, the RAN (radio access network) side (e.g., an NG-RAN (next generation radio access network) node) may receive the UAV ID and the UAV Differentiation Information from the UAV. In some embodiments, the UAV ID and the UAV Differentiation Information may be sent from the RAN side to the core network via the NG interface.

In some embodiments, after receiving the information, the core network could allocate the Group ID for the UAV, and send the Group ID and UAV Group Authorized Information to the NG-RAN node via the NG interface.

Alternatively, in some embodiments, the core network may get the UAV ID and UAV Differentiation Information from the UAV directly via NAS signaling and generate the Group ID and UAV Group Authorized Information according to the UAV ID and UAV Differentiation Information. Subsequently, the core network may transmit the Group ID and UAV Group Authorized Information to the NG-RAN node via the NG interface.

In some embodiments, the UAV grouping related information may be exchanged over the Xn interface.

With the Group ID and UAV Group Authorized Information, the NG-RAN node can be aware of the grouping status of specific UAVs, allocate the network resource, control the access of specific UAVs, and adjust the schedule of handover, including the cell handover, beam switching and multiple Transmission/Reception Points (TRPs) switching.

### Embodiment 1 (UAV Grouping Information Reporting Between Core Network and RAN)

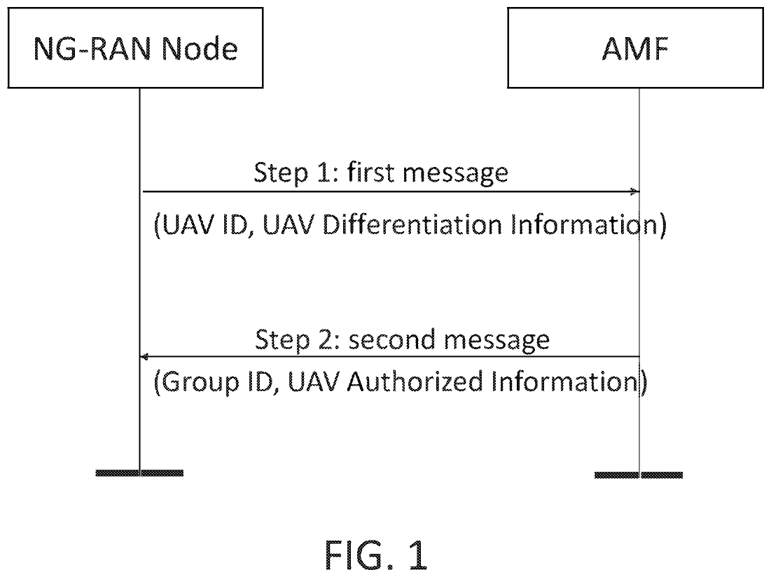

FIG. 1 shows a schematic diagram of transmitting UAV grouping information according to an embodiment of the present disclosure.

In this embodiment, the first and second message are NG interface signaling. In this embodiment, the first message can be but is not limited to a RAN Configuration Update message, a Handover Required message, a Path Switch Request message, a PDU (Protocol Data Unit) Session Resource Modify Indication message, an Initial UE Message, or an Uplink NAS Transport message. In this embodiment, the second message can be but is not limited to a RAN Configuration Update Acknowledge message, a Handover Command message, a Path Switch Request Acknowledge message, a PDU Session Resource Modify Confirm message, or a Downlink NAS Transport message.

Step 1: The NG-RAN node sends the first message to the AMF. In an embodiment, the first message includes at least one of a UAV ID and/or UAV Differentiation Information corresponding to one or more UAVs. In an embodiment, the UAV Differentiation Information can include at least one of the parameters corresponding to one or more UAVs, including: a scheduled communication time, a stationary indication, a power consumption level, flight path information, and/or flight height information.

Step 2: With the at least one of the UAV ID and/or the UAV Differentiation Information, the AMF may generate at least one of the Group ID and/or the UAV Group Authorized Information, and send the at least one of the Group ID and/or the UAV Group Authorized Information to the NG-RAN node via the second message. In an embodiment, the UAV Group Authorized Information is to indicate whether the UAV is authorized to work in a group.

With the procedure described above, the NG-RAN node can be aware of the grouping status of specific UAVs, allocate the network resource, control the access of specific UAVs, and adjust the schedule of handover, including the cell handover, beam switching and multiple TRPs switching.

Note that in some embodiments, the AMF may be replaced by another entity in the core network, and the present disclosure is not limited to the embodiment described above.

### Embodiment 2 (UAV Grouping Information Reporting from Core Network to RAN)

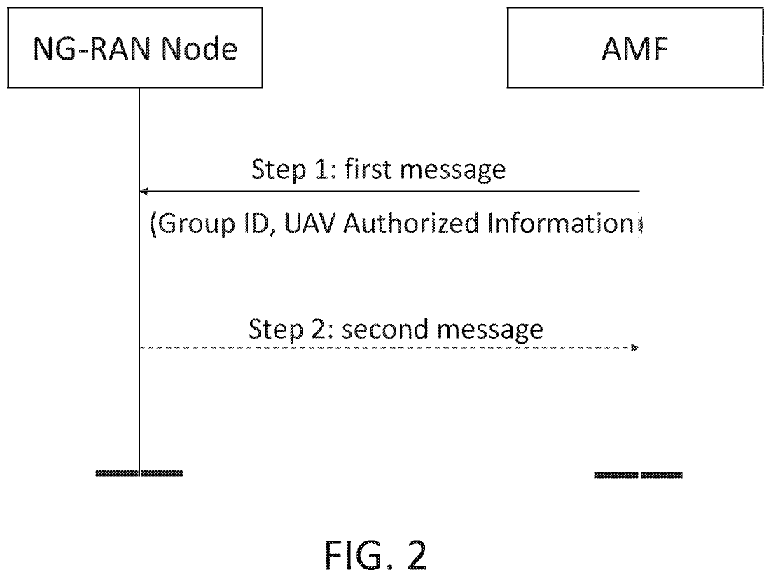

FIG. 2 shows a schematic diagram of transmitting UAV grouping information according to an embodiment of the present disclosure.

In this embodiment, the first and second message are NG interface signaling. In an embodiment, the first message can be but is not limited to an Initial UE Context Setup Request message or a Handover Request message. In an embodiment, the second message can be but is not limited to an Initial UE Context Setup Response message or a Handover Request Acknowledgement message.

In an embodiment, the first message may be a Downlink RAN Configuration Transfer message or a Downlink NAS Transport message. In such case, transmission of the second message described below may be omitted.

In this embodiment, the AMF may get at least one of a UAV ID and UAV Differentiation Information directly from the UAV via NAS signaling.

Step 1: After getting the at least one of the UAV ID and/or the UAV Differentiation Information from the UAV, the AMF may generate at least one of a Group ID and/or UAV Group Authorized Information according to the at least one of the UAV ID and/or the UAV Differentiation Information. Subsequently, the AMF may send the at least one of a Group ID and/or UAV Group Authorized Information to the NG-RAN node via the first message. In an embodiment, the UAV Group Authorized Information is to indicate whether the UAV is authorized to work in a group.

Step 2: The NG-RAN node may send the second message to the AMF. In an embodiment, the second message includes an acknowledgement message.

With the procedure described above, the NG-RAN node can be aware of the grouping status of specific UAVs, allocate the network resource, control the access of specific UAVs, and adjust the schedule of handover, including the cell handover, beam switching and multiple TRPs switching.

Note that, in some embodiments, the AMF may be replaced by another entity in the core network, and the present disclosure is not limited to the embodiment described above.

### Embodiment 3 (Exchange of UAV Related Information Between Two NG-RAN Nodes)

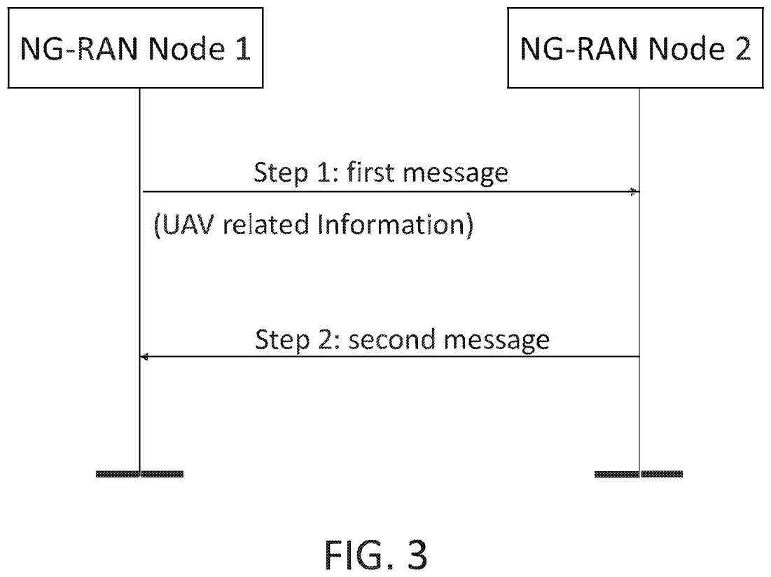

FIG. 3 shows a schematic diagram of transmitting UAV related information between two NG-RAN nodes according to an embodiment of the present disclosure.

In this embodiment, the first and second message are Xn interface signaling. In this embodiment, the first message can be but is not limited to an NG-RAN Configuration Update message, a Handover Request message, or a Retrieve UE Context Request message. In this embodiment, the second message can be but is not limited to an NG-RAN Configuration Acknowledge message, a Handover Request Acknowledge message, or a Retrieve UE Context Response message.

Step 1: The NG-RAN node 1 sends the first message to the NG-RAN node 2. In an embodiment, the first message includes UAV related information. In an embodiment, the UAV related information includes at least one of: a UAV ID, UAV Differentiation Information, a Group ID, and/or UAV Group Authorized Information.

In an embodiment, the UAV Differentiation Information can include at least one of: a scheduled communication time, a stationary indication, a power consumption level, flight path information, and/or flight height information corresponding t one or more UAVs.

Step 2: The NG-RAN node 2 may send the second message to the NG-RAN node 1. In an embodiment, the second message includes an acknowledgement message.

With the procedure described above, the NG-RAN node 2 can be aware of the grouping status of specific UAVs, allocate the network resource, control the access of specific UAVs, and adjust the schedule of handover, including the cell handover, beam switching and multiple TRPs switching.

According to some embodiments of the present disclosure, for the UAV communication in the wireless communication network, the UAV grouping related information may be exchanged between two different wireless communication nodes.

According to some embodiments of the present disclosure, the UAV grouping related information can include one of: a UAV ID, UAV Differentiation Information, a Group ID, UAV Group Authorized Information.

According to some embodiments of the present disclosure, the UAV Differentiation Information can comprise at least one of: a scheduled communication time, a stationary indication, a power consumption level, flight path information, flight height information.

According to some embodiments of the present disclosure, the UAV Group Authorized Information is to indicate whether the UAV is authorized to work in a group.

According to some embodiments of the present disclosure, if the first wireless communication node is an AMF and the second wireless communication node is an NG-RAN node, the NG-RAN node transmits the first message to the AMF, and the UAV ID and UAV differentiation information are included in the first message. After receiving the first message, the AMF may send the second message to the NG-RAN node with a Group ID and UAV Group Authorized Information.

According to some alternative embodiments of the present disclosure, the AMF can get the UAV ID and the UAV differentiation information from a UE (e.g., a UAV) directly via NAS signaling and transmit the first message to the NG-RAN node. The first message may include at least one of the Group ID and UAV Group Authorized Information.

According to some embodiments of the present disclosure, if both of the two wireless communication nodes are NG-RAN nodes, one of the NG-RAN nodes transmits the first message to another of the NG-RAN nodes, and the UAV grouping related information is included in the first message.

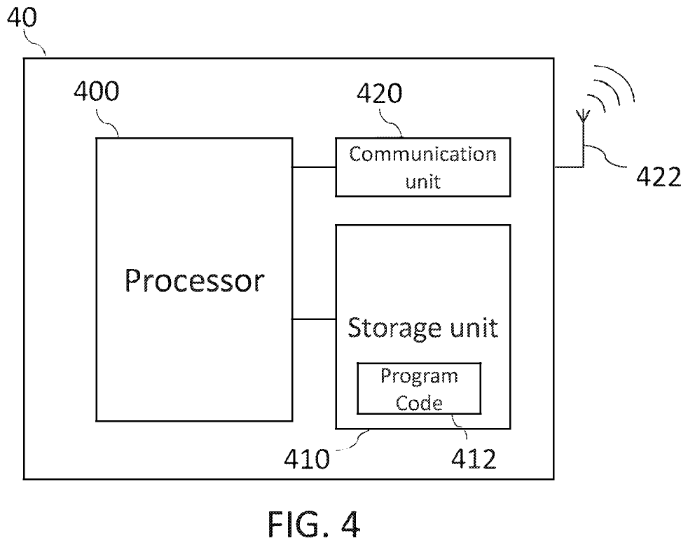

FIG. 4 relates to a schematic diagram of a wireless communication node 40 (e.g., a network device) according to an embodiment of the present disclosure. The wireless communication node 40 may be a satellite, a base station (BS) (e.g., a gNB), a unit of a BS (e.g., a gNB-CU), a network entity, a Mobility Management Entity (MME), Serving Gateway (S-GW), Packet Data Network (PDN) Gateway (P-GW), a radio access network (RAN), a next generation RAN (NG-RAN), a data network, a core network or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from another wireless communication node or a UAV.

In some embodiments, the wireless communication node 40 may be used to perform the operations of the first node described above. In some embodiments, the processor 400 and the communication unit 420 collaboratively perform the operations described above. For example, the processor 400 performs operations and transmit or receive signals through the communication unit 420.

A wireless communication method is also provided according to an embodiment of the present disclosure. In an embodiment, the wireless communication method may be performed by using a wireless communication node (e.g., an AMF). In an embodiment, the wireless communication terminal may be implemented by using the wireless communication node 40 described above, but is not limited thereto.

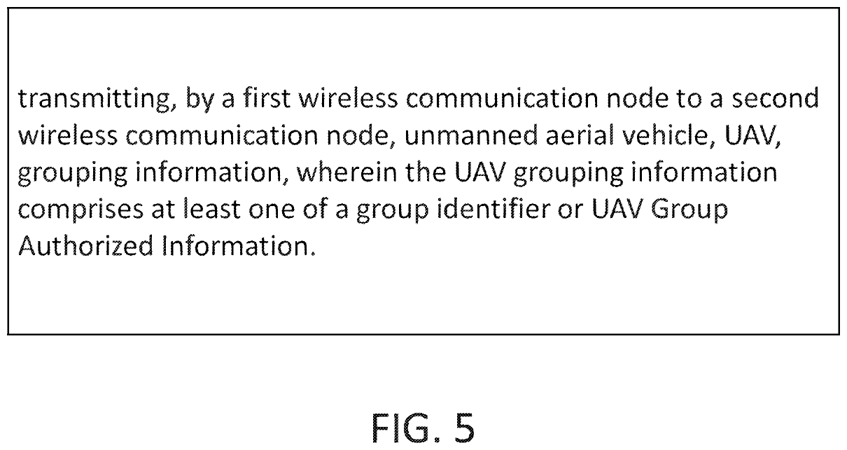

Referring to FIG. 5, in an embodiment, the wireless communication method includes: transmitting, by a first wireless communication node to a second wireless communication node, unmanned aerial vehicle, UAV, grouping information, wherein the UAV grouping information comprises at least one of a group identifier or UAV Group Authorized Information.

In an embodiment, the first wireless communication node may be the AMF described above, but is not limited thereto.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., an NG-RAN node). In an embodiment, the wireless communication terminal may be implemented by using the wireless communication node 40 described above, but is not limited thereto.

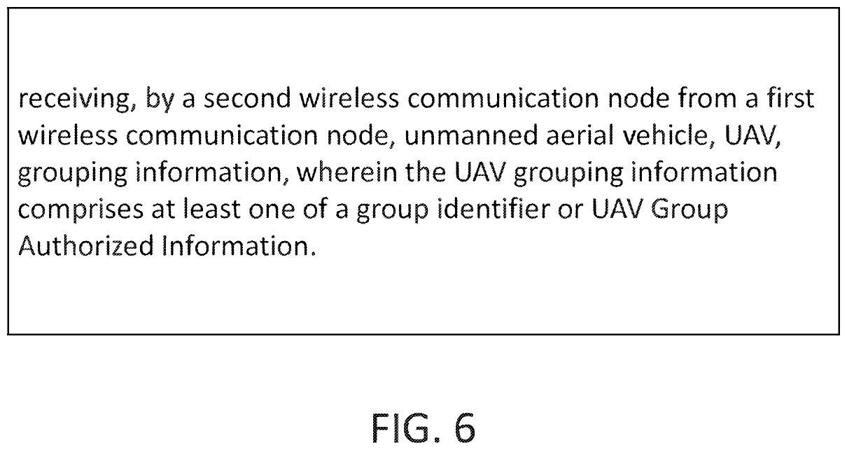

Referring to FIG. 6, in an embodiment, the wireless communication method includes: receiving, by a second wireless communication node from a first wireless communication node, unmanned aerial vehicle, UAV, grouping information, wherein the UAV grouping information comprises at least one of a group identifier or UAV Group Authorized Information.

In an embodiment, the first wireless communication node may be the NG-RAN node or the NG-RAN node 1 described above, but is not limited thereto.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., an NG-RAN node). In an embodiment, the wireless communication terminal may be implemented by using the wireless communication node 40 described above, but is not limited thereto.

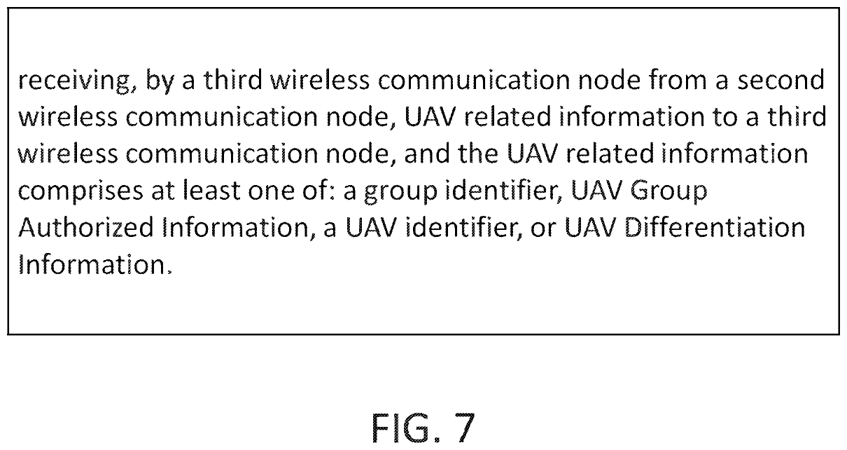

Referring to FIG. 7, in an embodiment, the wireless communication method includes: receiving, by a third wireless communication node from a second wireless communication node, UAV related information to a third wireless communication node, and the UAV related information comprises at least one of: a group identifier, UAV Group Authorized Information, a UAV identifier, or UAV Differentiation Information.

In an embodiment, the third wireless communication node may be the NG-RAN node 2 described above, but is not limited thereto.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method comprising:
transmitting, by a first wireless communication node to a second wireless communication node, unmanned aerial vehicle (UAV) grouping information,
wherein the UAV grouping information comprises at least one of a group identifier or UAV Group Authorized Information.

2. The wireless communication method of claim 1, wherein the UAV Group Authorized Information indicates whether a UAV is authorized to work in a group.

3. The wireless communication method of claim 1, wherein the first wireless communication node is configured to receive UAV information, and transmit the UAV grouping information according to the UAV information.

4. The wireless communication method of claim 3, wherein the UAV information comprises at least one of a UAV identifier or UAV Differentiation Information.

5. The wireless communication method of claim 4, wherein the UAV Differentiation Information comprises at least one of a scheduled communication time, a stationary indication, a power consumption level, flight path information, or flight height information.

6. The wireless communication method of claim 3, wherein the UAV information is received from the second wireless communication node, and the UAV information is transmitted via a Radio Access Network (RAN) Configuration Update message, a Handover Required message, a Path Switch Request message, a Protocol Data Unit (PDU) Session Resource Modify Indication message, an Initial UE Message message, or an Uplink Non-access stratum (NAS) Transport message.

7. The wireless communication method of claim 3, wherein the UAV information is received from the second wireless communication node, and the UAV grouping information is transmitted via a RAN Configuration Update Acknowledge message, a Handover Command message, a Path Switch Request Acknowledge message, a PDU Session Resource Modify Confirm message, or a Downlink Non-access stratum (NAS) Transport message.

8. The wireless communication method of claim 3, wherein the UAV information is received from a UAV, and the UAV grouping information is transmitted via an Initial User Equipment (UE) Context Setup Request message, a Handover Request message, a Downlink RAN Configuration Transfer message, or a Downlink Non-access stratum (NAS) Transport message.

9. The wireless communication method of claim 8, wherein the UAV information is received from the UAV via NAS signaling.

10. The wireless communication method of claim 1, wherein the first wireless communication node is configured to receive a response message from the second wireless communication node, and the response message is transmitted via an Initial User Equipment (UE) Context Setup Response message or a Handover Request Acknowledgement message.

11. A wireless communication method comprising:
receiving, by a second wireless communication node from a first wireless communication node, unmanned aerial vehicle (UAV) grouping information,
wherein the UAV grouping information comprises at least one of a group identifier or UAV Group Authorized Information.

12. The wireless communication method of claim 11, wherein the second wireless communication node is configured to transmit UAV information to the first wireless communication node, and receive the UAV grouping information in response to the UAV information.

13. The wireless communication method of claim 11, wherein the second wireless communication node is configured to transmit UAV related information to a third wireless communication node, and the UAV related information comprises at least one of: a group identifier, UAV Group Authorized Information, a UAV identifier, or UAV Differentiation Information.

14. The wireless communication method of claim 13, wherein the UAV related information is transmitted via a Next Generation Radio Access Network (NG-RAN) Configuration Update message, a Handover Request message, or a Retrieve User Equipment (UE) Context Request message.

15. The wireless communication method of claim 13, wherein the second wireless communication node is configured to receive a response message from the third wireless communication node, and the response message is transmitted via a Next Generation Radio Access Network (NG-RAN) Configuration Acknowledge message, a Handover Request Acknowledge message, or a Retrieve UE Context Response message.

16. A wireless communication method comprising:
receiving, by a third wireless communication node from a second wireless communication node, unmanned aerial vehicle (UAV) related information,
wherein the UAV related information comprises at least one of: a group identifier, UAV Group Authorized Information, a UAV identifier, or UAV Differentiation Information.

17. The wireless communication method of claim 16, wherein the third wireless communication node is configured to transmit a response message to the second wireless communication node, and the response message is transmitted via a Next Generation Radio Access Network (NG-RAN) Configuration Acknowledge message, a Handover Request Acknowledge message, or a Retrieve User Equipment (UE) Context Response message.

18. A wireless communication node, comprising:
a communication unit; and
a processor configured to perform a wireless communication method of claim 1.

19. A wireless communication node, comprising:
a communication unit; and
a processor configured to perform the wireless communication method of claim 11.

20. A wireless communication node, comprising:
a communication unit; and
a processor configured to perform the wireless communication method of claim 16.
